(19) United States
(12) Patent Application Publication
(10) Pub. No.: US 2009/0315988 A1
(43) Pub. Date: Dec. 24, 2009

(54) OBSERVATION DEVICE, INSPECTION DEVICE AND INSPECTION METHOD

(76) Inventor: Kazuhiko FUKAZAWA, Kamakura-shi (JP)

Correspondence Address: MORGAN LEWIS & BOCKIUS LLP, 1111 PENNSYLVANIA AVENUE NW, WASHINGTON, DC, 20004, US

(21) Appl. No.: 12/549,155

(22) Filed: Aug. 27, 2009

Related U.S. Application Data
(63) Continuation of application No. PCT/JP2008/053415, filed on Feb. 27, 2008.

(30) Foreign Application Priority Data
Feb. 28, 2007 (JP) 2007-050821

(51) Int. Cl. H04N 7/18

(52) U.S. Cl. 348/126; 348/E07.085

(57) ABSTRACT

An inspection device is configured having: an illumination unit that illuminates a wafer with illumination light having a plurality of kinds of wavelengths; a photographing unit that photographs the image of the wafer illuminated with the illumination light; and an image processing unit that generates an inspection image of the wafer photographed by the photographing unit, by performing a predetermined weighting for each of the plurality of kinds of wavelengths, and judges whether any defect is present in the wafer based on the generated inspection image.

This is a continuation of PCT International Application No. PCT/JP2008/053415, filed on Feb. 27, 2008, which is hereby incorporated by reference. This application also claims the benefit of Japanese Patent Application No. 2007-050821, filed in Japan on Feb. 28, 2007, which is hereby incorporated by reference.

### TECHNICAL FIELD

The present invention relates to an observation device for observing the surface of an inspection target substrate, represented by, for example, a semiconductor wafer, and an inspection device and inspection method for inspecting the surface of an inspection target substrate.

### TECHNICAL BACKGROUND

Various devices have been proposed as devices to observe or inspect the abnormalities of patterns formed on the surface of a semiconductor wafer (hereafter called wafer), and scratches and foreign substances on a resist (photosensitive resin film) (e.g. see Patent Document 1). Such inspections of wafers are largely classified into a destructive inspection and a non-destructive inspection. An example of a destructive inspection is an inspection using SEM (Scanning Electron Microscope), and an example of a non-destructive inspection is a visual inspection, an inspection by illuminating the wafer surface, and photographing and analyzing the reflected lights thereof.

It is desirable to perform an inspection of wafers in each fabrication step, but the most critical is the inspection performed in a stage after exposure and development of the pattern, in which the wafer can be recovered if defects are discovered. In the semiconductor fabrication steps, after a predetermined circuit pattern is exposed on the resist-coated surface of the wafer, many steps are performed, including development, etching, sputtering, doping and CMP (Chemical Mechanical Polishing), then resist is coated again, and another circuit pattern is exposed, and hereafter a plurality of layers are superimposed via similar steps.

Patent Document 1: Japanese Patent Application Laid-Open No. 2006-135211

### DISCLOSURE OF THE INVENTION

### Problems to be Solved by the Invention

If the circuit pattern on the top layer is irradiated in this stage and the reflected lights thereof are photographed and inspected, however, the illumination light causes interference in the underlayer portion because of the circuit pattern of the top layer, and if the shape of the underlayer portion is not uniform, the degree of interference also becomes uneven, then interference lights, of which brightness is not uniform, may be included in the reflected lights. The interference lights, of which brightness is not uniform, appear as variable densities in the wafer image generated by the reflected lights, which makes it difficult to distinguish the variable densities generated by the influence of scratches and foreign substances and the variable densities generated by the interference lights of which brightness is not uniform, and as a result, the accuracy of the wafer inspection is decreased.

With the foregoing in view, it is an object of the present invention to provide an observation device, inspection device and inspection method in which the influence of the underlayer is decreased when an inspection target substrate is inspected (observed).

To achieve this object, an observation device according to the present invention comprises: an illumination unit that illuminates an inspection target substrate with illumination light having a plurality of kinds of wavelengths; a photographing unit that photographs the inspection target substrate illuminated with the illumination light; and a photographed image generation unit that generates an observation image of the inspection target substrate photographed by the photographing unit, by performing weighting for each of the plurality of kinds of wavelengths.

In the above observation device, the photographing unit further comprises a plurality of image sensing elements disposed corresponding to the plurality of kinds of wavelengths, and an imaging optical system that splits the light from the inspection target substrate into each of the plurality of kinds of wavelengths, and guides the split lights to the plurality of image sensing elements respectively, and the photographed image generation unit generates the observation image, by weighting the image photographed for each of the plurality of kinds of wavelengths by the plurality of image sensing elements, and synthesizing the same.

An inspection device according to the present invention comprises: an illumination unit that illuminates an inspection target substrate with illumination light having a plurality of kinds of wavelengths; a photographing unit that photographs the inspection target substrate illuminated with the illumination light; a photographed image generation unit that generates an inspection image of the inspection target substrate, for which weighting is performed for each of the plurality of kinds of wavelengths; and a judgment unit that judges whether any defect is present on the inspection target substrate based on the inspection image generated by the photographed image generation unit.

In the above inspection device, it is preferable that the illumination light that illuminates the inspection target substrate by the illumination unit is parallel light, and the photographing unit photographs an image of the inspection target substrate generated by a specular reflected light from the inspection target substrate.

In the above inspection device, it is preferable that a predetermined repeat pattern is formed on a surface of the inspection target substrate, the inspection device further comprising: a first polarizing element that sends a first polarized state light, out of the illumination light, to the inspection target substrate; a holding unit that holds the inspection target substrate so that the first polarized state on the surface of the inspection target substrate becomes diagonal with respect to the repeating direction of the repeat pattern; and a second polarizing element that sends a second polarized state light, which is perpendicular to the first polarized state light, out of the reflected light from the inspection target substrate, to the photographing unit, and the photographing unit photographs an image of the inspection target substrate formed by the second polarized state light.

In the above inspection device, it is preferable that the illumination unit further comprises: a plurality of illuminators which are disposed corresponding to the plurality of kinds of wavelengths, and each of which emits an illumination light having any of the plurality of kinds of wavelengths, that is, different from the wavelengths of the other illuminators; and a condensing optical system that synthesizes the illumination lights emitted from the plurality of illuminators, and guides the same to the inspection target substrate.

In the above inspection device, it is preferable that the plurality of kinds of wavelengths are set by at least three kinds of wavelengths, and for a weighting ratio, the predetermined standard substrate is illuminated by the illumination unit and photographed by the photographing unit, and a ratio is set, at which an inspection image of the standard substrate generated by the photographed image generation unit is substantially the same as an actual image of the standard substrate.

In the above inspection device, it is preferable that the photographing unit comprises a plurality of image sensing elements disposed corresponding to the plurality of kinds of wavelengths, and an imaging optical system that splits a light from the inspection target substrate into the plurality of kinds of wavelengths and guides each light into the plurality of light sensing elements respectively, and the photographed image generation unit generates the inspection image by performing weighting and synthesizing the images photographed for each of the plurality of kinds of wavelengths by the plurality of image sensing elements respectively.

An inspection method of the present invention comprises: illuminating an inspection target substrate with illumination light having a plurality of kinds of wavelengths; photographing the inspection target substrate illuminated by the illumination light; generating an inspection image of the photographed inspection target substrate, by performing weighting for each of the plurality of kinds of wavelengths; and judging whether any defect is present on the inspection target substrate based on the generated inspection image.

In the above inspection method, it is preferable that the light from the inspection target substrate is split into each of a plurality of kinds of wavelengths when the inspection target substrate is photographed, and the inspection image is generated by performing weighting and synthesizing the images photographed for each of the plurality of kinds of wavelengths respectively.

### ADVANTAGEOUS EFFECTS OF THE INVENTION

According to the present invention, the influence of the underlayer when the inspection target substrate is inspected (observed) can be decreased.

### BRIEF DESCRIPTION OF THE DRAWINGS

FIG. 1 is a diagram depicting a general configuration of an inspection device according to a first embodiment;

FIG. 2 is a diagram depicting a configuration of an illumination unit;

FIG. 3 is a diagram depicting a configuration of a photographing unit;

FIG. 4 is a diagram depicting an example of a photographed image of a wafer;

FIG. 5 is a cross-sectional view depicting an example of a wafer;

FIG. 6 is a graph depicting characteristics of brightness of an interference light with respect to the film thickness of a processed film on a wafer;

FIG. 7 is a diagram depicting a general configuration of an inspection device according to a second embodiment;

FIG. 8 is an external view of a wafer surface;

FIG. 9 is a perspective view depicting a bumped structure of a repeat pattern;

FIG. 10 is a diagram depicting a tilted state of an entrance plane of a linearly polarized light and repeating direction of the repeat pattern;

FIG. 11 is a diagram depicting a vibrating direction of a linearly polarized light and elliptically polarized light;

FIG. 12 is a diagram depicting a tilted state of the direction of the vibrating plane of linearly polarized light and repeating direction of the repeat pattern;

FIG. 13 is a diagram depicting a state of the direction of the vibrating plane of the linear polarization split into a polarization component, which is in parallel with the repeating direction, and a polarization component, which is perpendicular to the repeating direction;

FIG. 14 is a graph depicting a relationship of the magnitude of the polarization component and the line width of a line portion of the repeat pattern;

FIG. 15 is a diagram depicting a variant form of the inspection device;

FIG. 16 is a flow chart depicting an inspection method for a wafer surface using the inspection device of the first and second embodiments;

FIG. 17 is an image photographed by illuminating a wafer with e-line rays in the inspection device of the first embodiment;

FIG. 18 is an image photographed by illuminating a wafer with g-line rays in the inspection device of the first embodiment;

FIG. 19 is an image photographed by illuminating a wafer with h-line rays in the inspection device of the first embodiment; and

FIG. 20 is an image when the image in FIG. 17 and the image in FIG. 19 are synthesized in the inspection device of the first embodiment.

### DESCRIPTION OF THE PREFERRED EMBODIMENTS

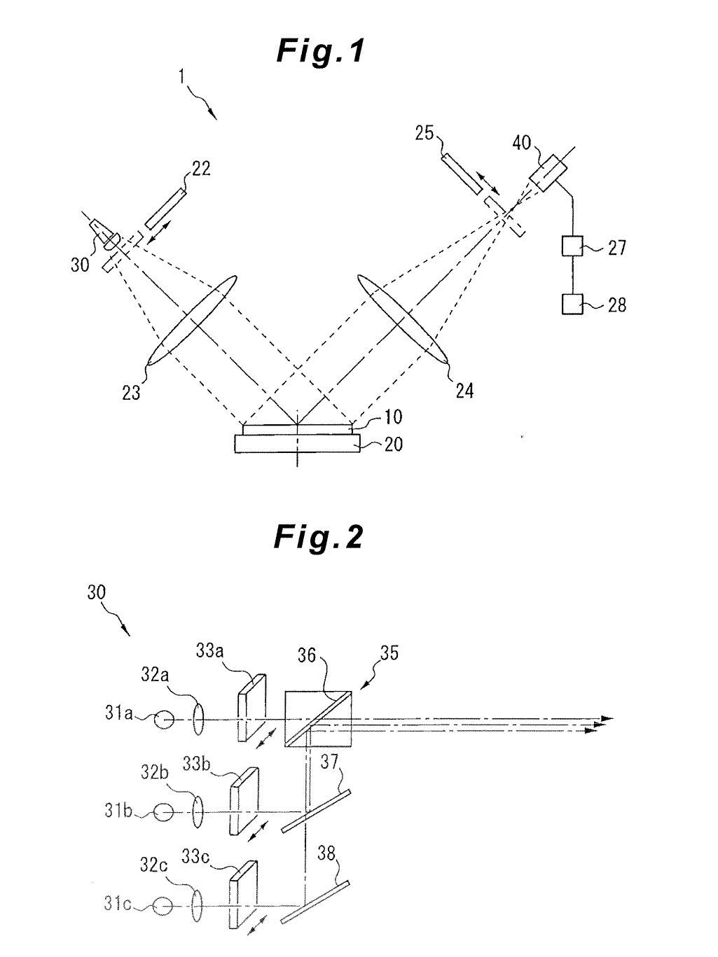

Preferred embodiments of the present invention will now be described with reference to the drawings. As FIG. 1 shows, an inspection device 1a of the first embodiment is comprised of: a stage 20 that supports a wafer 10, which is an inspection target substrate; an illumination unit 30 that illuminates the wafer 10 with an illumination light having three kinds of wavelengths; a photographing unit 40 that photographs the wafer 10 illuminated by the illumination light; an illumination optical system 23; an observation optical system 24; an image processing unit 27; and an image display device 28. The inspection device 1a is a device that automatically inspects the surface of a wafer 10 in the fabrication steps of a semiconductor circuit element. After resist film in the top layer of the wafer 10 is exposed and developed, the wafer 10 is transported by a transport system, which is not illustrated, from a wafer cassette or a development device, which are not illustrated, to the stage 20, and held by suction.

The stage 20 rotatably holds the wafer 10, with the normal line passing through the center of the stage 20 (wafer 10) (that is, the axis extending vertically in FIG. 1) as the rotation axis. The stage 20 can tilt the wafer 10 with the axis extending in a direction perpendicular to the rotation axis and the traveling direction of the illumination light (that is, the back to front direction in FIG. 1), so as to adjust the entrance angle of the illumination light.

As FIG. 2 shows, the illumination unit 30 is comprised of three illuminators, 31a, 31b and 31c, which are disposed corresponding to the above mentioned three kinds of wavelengths, and a condensing optical system 35 that synthesizes the illumination light emitted from each illuminator 31a, 31b and 31c, and guides it to the wafer 10. Although detailed illustration is omitted, the first illuminator 31a is comprised of a light source, such as a xenon lamp or mercury lamp, and an interference filter (bandpass filter) that extracts a desired wavelength component (bright line spectrum) out of the light from the light source, and is designed to emit an illumination light having a first wavelength, which is one of the above mentioned three kinds of wavelengths.

The second illuminator 31b has a similar configuration as the first illuminator 31a, but is designed to emit an illumination light having a second wavelength, which is one of the three kinds of wavelengths. The third illuminator 31c also has a similar configuration as the first illuminator 31a, but is designed to emit an illumination light having a third wavelength, which is one of the three kinds of wavelengths. This means that each of the three illuminators, 31a, 31b and 31c, emits an illumination light having one of the three kinds of wavelengths, which is different from the others. Actually each of the three illuminators, 31a, 31b and 31c, emits an illumination light having a first to third wavelength±10 nm to 30 nm respectively.

The condensing optical system 35 is comprised of three condensing lenses: 32a, 32b and 32c; and three mirrors: 36, 37 and 38. The first condensing lens 32a condenses the illumination light having the first wavelength emitted from the first illuminator 31a, and guides it to the first mirror 36. The second condensing lens 32b condenses the illumination light having the second wavelength emitted from the second illuminator 31b, and guides it to the second mirror 37. The third condensing lens 32c condenses the illumination light having the third wavelength emitted from the third illuminator 31c, and guides it to the third mirror 38.

The third mirror 38 is an ordinary reflecting mirror. The third mirror 38 is designed such that the illumination light having the third wavelength from the third condensing lens 32c is reflected and is directed toward the second mirror 37. The second mirror 37 is a so called “dichroic mirror”. The second mirror 37 is designed such as that the illumination light having the second wavelength from the second condensing lens 32b is reflected and is directed toward the first mirror 36, and the illumination light having the third wavelength from the third mirror 38 transmits and is directed to the first mirror 36.

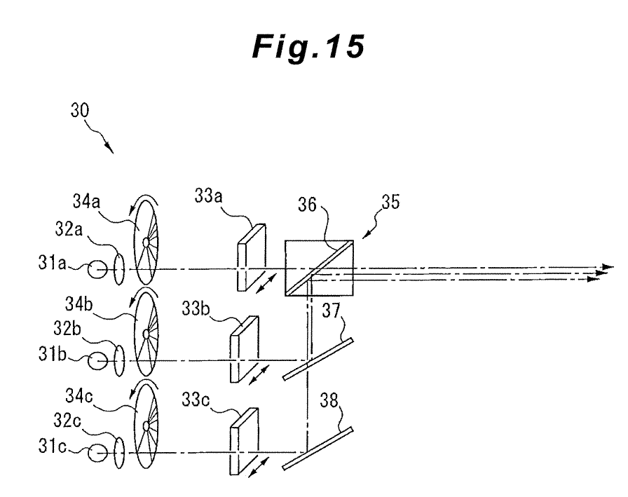

The first mirror 36 is also a dichroic mirror. The first mirror 36 is designed such that the illumination light having the first wavelength from the first condensing lens 32a transmits and is directed to the surface of the wafer 10, and the illumination light having the second and third wavelengths from the second mirror 37 is reflected and is directed to the surface of the wafer 10. In the first mirror 36 and the second mirror 37, the illumination lights having the first to third wavelengths are synthesized and guided to the wafer 10. In FIG. 2 (FIG. 15 as well), the optical axes of the illumination lights having the first to third wavelengths are separately shown for explanation, but these lights are actually synthesized, and the optical axes of the illumination lights match.

A first shutter 33a is disposed between the first condensing lens 32a and the first mirror 36, so as to interrupt or not interrupt the optical path, and switch the illumination ON/OFF by the first illuminator 31a. A second shutter 33b is disposed between the second condensing lens 32b and the second mirror 37, so as to interrupt or not interrupt the optical path, and switch illumination ON/OFF by the second illuminator 31b. A third shutter 33c is disposed between the third condensing lens 32c and the third mirror 38, so as to interrupt or not interrupt the optical path, and switch illumination ON/OFF by the third illuminator 31c.

As FIG. 1 shows, the illumination optical system 23 is a telecentric optical system which makes the illumination light from the illumination unit 30 parallel lights, and guides them to the surface of the wafer 10. An illumination side polarizing filter 22 is disposed between the illumination unit 30 and the illumination optical system 23, so as to interrupt or not interrupt the optical path, but in the configuration of the first embodiment, the illumination side polarizing filter 22 is disposed so as not to interrupt the optical path (the illumination side polarizing filter 22 will be described in detail later).

The observation optical system 24 is an optical system which condenses the light reflected on the surface of the wafer 10, and directs it to the photographing unit 40. A receive side polarizing filter 25 is disposed between the observation optical system 24 and the photographing unit 40 so as to interrupt or not interrupt the optical path, but in the configuration of the first embodiment, the receive side polarizing filter 25 is disposed so as not to interrupt the optical path (the receive side polarizing filter 25 will be described in detail later). In this way, according to the first embodiment, the illumination side polarizing filter 22 and the receive side polarizing filter 25 are disposed so as not to interrupt the optical path, therefore the illumination light from the illumination unit 30 for illuminating the wafer 10 becomes parallel lights, and the photographing unit 40 photographs an image (of the wafer 10) by the specular reflected light from the wafer 10.

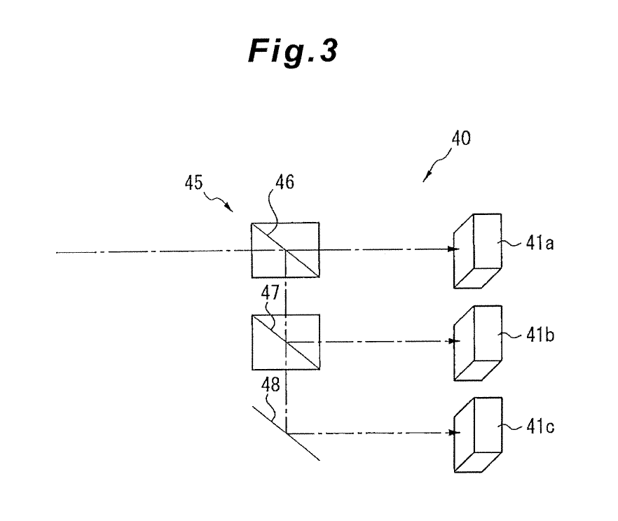

As FIG. 3 shows, the photographing unit 40 is comprised of: three image sensing elements, 41a, 41b and 41c, which are disposed corresponding to the three kinds of wavelengths; and an imaging optical system 45, which splits the reflected light from the wafer 10 for each of the three kinds of wavelengths, and guides them to the three image sensing elements 41a, 41b and 41c respectively. The first to third image sensing elements 41a, 41b and 41c are amplification type solid image sensing elements, such as CCD and CMOS, and photo-electric-transforms the image of the wafer 10 formed on the element, and outputs the image signals to the image processing unit 27.

The imaging optical system 45 is comprised of three mirrors, 46, 47 and 48. The fourth mirror 46 is a so called “dichroic mirror”. The fourth mirror 46 is designed such that the reflected light having the first wavelength from the wafer 10 transmits and is directed toward the first image sensing element 41a, and the illumination lights having the second and third wavelengths are reflected and directed toward the fifth mirror 47. The fifth mirror 47 is also a dichroic mirror. The fifth mirror 47 is designed such that the reflected light having the second wavelength from the fourth mirror 46 is reflected and is directed toward the second image sensing element 41b, and the reflected light having the third wavelength from the fourth mirror 46 transmits and is directed toward the sixth mirror 48.

The sixth mirror 48 is an ordinary reflecting mirror. The sixth mirror 48 is designed such that the reflected light having the third wavelength from the fifth mirror 47 is reflected and is directed toward the third image sensing element 41c. In this way, in the fourth mirror 46 and the fifth mirror 47, the reflected light from the wafer 10 is split into reflected lights having a first to third wavelengths, and guided to the first to third image sensing elements 41a, 41b and 41c respectively.

The image processing unit 27 receives the images (of the wafer 10) photographed for each of the three types of wavelengths based on the image signals that are output from the first to third image sensing elements 41a, 41b and 41c of the photographing unit 40, and generates an inspection image of the wafer 10 by performing a predetermined image processing on the received photographed images. In the image processing unit 27, the photographed image (reflective image) of a non-defective wafer (not illustrated), to be a standard substrate, has been stored in advance for comparison.

When the inspection image of the wafer 10, which is an inspection target substrate, is generated, the image processing unit 27 compares this brightness information with the brightness information of the photographed image of the non-defective wafer. At this time, defects on the surface of the wafer 10 are detected based on a brightness drop amount (change of light quantity) in a dark area of the inspection image. For example, “defect” is judged if the brightness drop amount is greater than a predetermined threshold (tolerance), and “normal” is judged if it is smaller than the threshold. Then the comparison result of the brightness information by the image processing unit 27 and the inspection image of the wafer 10 in this case are output to and displayed on the image display device 28.

In the image processing unit 27, an array data of the shot areas of the wafer 10 and the thresholds of the brightness values may be stored in advance, instead of storing the photographed images of the non-defect wafer. In this case, the position of each shot area in the inspection image of the wafer 10 is known based on the array data of the shot areas, so the brightness value of each shot area is determined. And a defect of the pattern is detected by comparing this brightness value and stored threshold. The shot area of which brightness value is smaller than the threshold can be judged as “defect”.

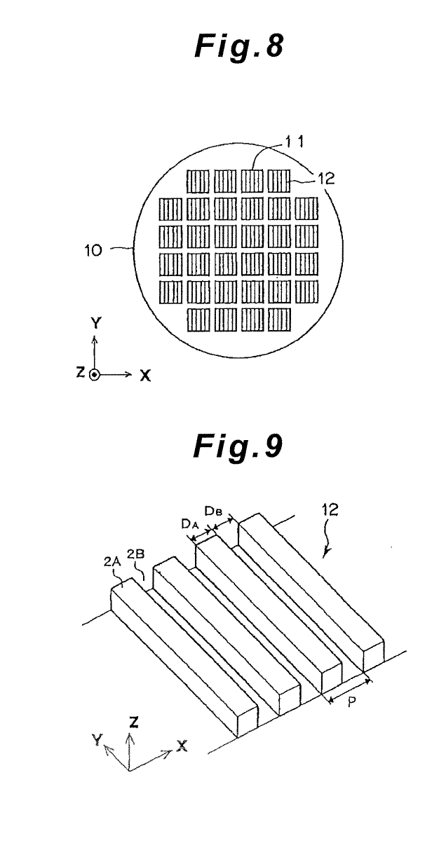

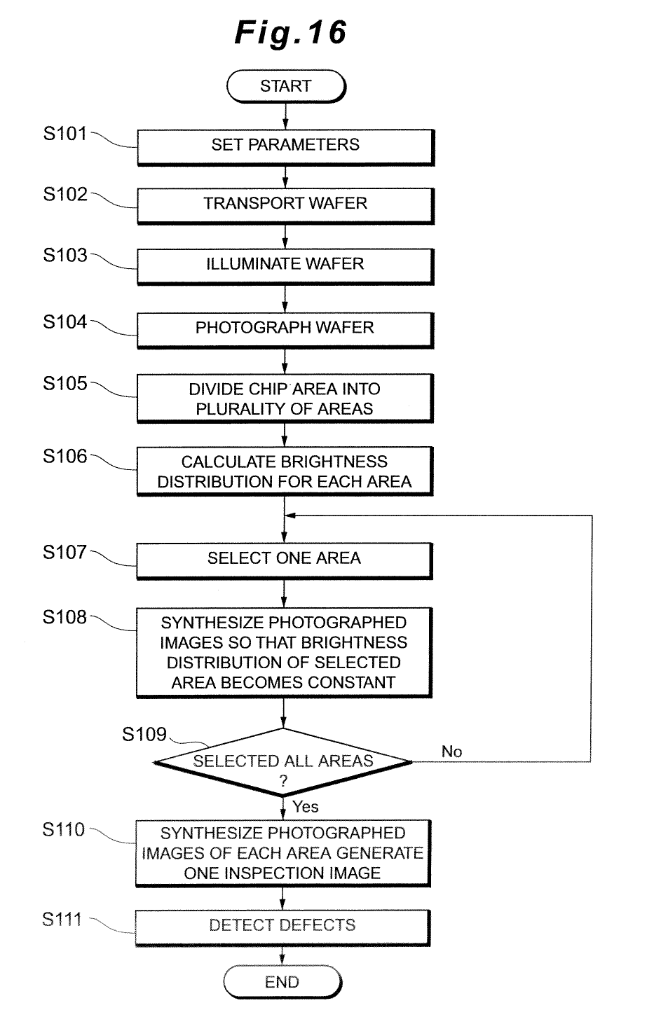

An inspection method for the surface of the wafer 10 using the inspection device 1a according to the first embodiment will now be described with reference to the flow chart shown in FIG. 16. First in step S101, parameters are set for the inspection target. The parameters include a shot size of the wafer 10, chip size, underlayer structure information, correction gain (weighting) for each wavelength, shot array and structure data in the chip area 11. On the surface of the wafer 10, a plurality of chip areas 11 are arrayed, as shown in an example of FIG. 8.

In step S102, the wafer 10 to be the inspection target is transported to the stage 20. At this time, the transported wafer 10 is held by the stage 20 by suction.

In step S103, the illumination unit 30 illuminates the wafer 10 with an illumination light having three kinds of wavelengths (first to third wavelengths). The illumination unit 30 emits illumination lights having first to third wavelengths respectively from the first to third illuminators 31a, 31b and 31c, and the illumination lights having the first to third wavelengths are synthesized by the condensing optical system 35, and guided to the wafer 10. Thereby the illumination lights having a plurality of kinds (three kinds) of wavelengths can be easily generated. The illumination lights emitted like this from the illumination unit 30 become parallel lights, and are emitted to the surface of the wafer 10 by the illumination optical system 23, and specular reflected light, which is reflected on the surface of the wafer 10, is condensed toward the photographing unit 40 by the observation optical system 24.

In step S104, the wafer 10 illuminated by the above mentioned illumination light is photographed and recorded by the photographing unit 40. At this time, the specular reflected light from the wafer 10 is split into each of the three kinds of wavelengths (first to third wavelengths) and guided to the first to third image sensing elements 41a, 41b and 41c by the imaging optical system 45, and the images (of the wafer 10) formed on the elements are photo-electric transformed in each image sensing element 41a, 41b and 41c and the image signals are output to the image processing unit 27.

When the images are photographed for each of the three kinds of wavelengths by the first to third image sensing elements 41a, 41b and 41c, the image processing unit 27, in steps S105 to S110, generates the inspection image of the wafer 10 by performing a predetermined weighting on the images photographed by the first to third image sensing elements 41a, 41b and 41c and synthesizing these weighted images. Specifically, each image (brightness) photographed by each image sensing element 41a, 41b, and 41c is multiplied by a gain corresponding to the weighting used for each of the three kinds of wavelengths. Thereby, a predetermined weighting can be performed only in image processing, so device configuration can be simplified.

For a weighting ratio, a non-defective wafer to be a standard wafer (not illustrated) is illuminated by the illumination unit 30, and is photographed by the photographing unit 40, and setting a weighting ratio, to be a ratio in which an inspection image of a non-defective wafer becomes substantially the same as an actual non-defective wafer, is preferable in photographing an inspection image of a non-defective wafer generated by the image processing unit 27. Thereby the influence of the underlayer, when the wafer 10 is inspected, can be decreased with certainty, and accuracy of the wafer inspection can be further improved.

Concerning step S105 to S110, the chip area 11 is further divided into a plurality of areas according to the structure data in the chip area 11 in step S105 first.

Then in step S106, a brightness distribution on the surface of the wafer 10 in an image photographed by each image sensing element 41a, 41b and 41c is calculated for each of the three kinds of wavelengths. At this time, the brightness distribution is calculated for each area divided in step S105.

In step S107, a photographed image (picture image) in one of the plurality of areas divided in step S105 is selected for each of the three kinds of wavelengths.

In step S108, the brightness of an area selected for each of the three kinds of wavelengths in step S107 is multiplied by a gain corresponding to the weighting for each of the three kinds of wavelengths (or offset is performed), so that the brightness distribution in the selected area becomes uniform, to synthesize a photographed image of the area for each wavelength.

In step S109, steps S107 to S108 are repeated until all the areas divided in step S105 are selected.

In step S110, the photographed images of each area generated such that the brightness distribution thereof becomes uniform are patched and synthesized to generate one inspection image.

When the inspection image of the wafer 10 is generated, as mentioned above, the image processing unit 27 compares the brightness information thereof with the brightness information of a photographed image of a non-defective wafer in step S111, so as to detect defects on the surface of the wafer 10, and judge whether there are any defects on the wafer 10.

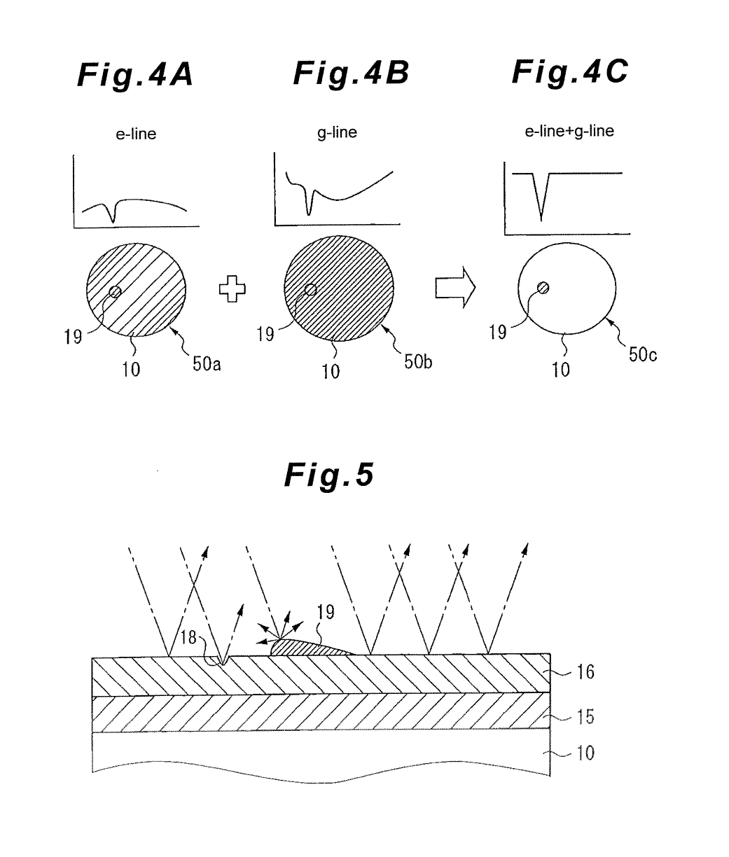

If a wafer 10, on which a foreign substance 19 is attached, is illuminated with an illumination light having a wavelength of an e-line (546 nm), as FIG. 4(a) shows, the photographed image 50a becomes dark in general, and has uneven density. If this wafer 10 is illuminated with an illumination light having a wavelength of g-line (436 nm), as FIG. 4(b) shows, the photographed image 50b becomes dark in general, where the presence of a foreign substance 19 cannot be recognized so easily. In FIG. 4, the distribution of density (brightness) in the photographed image is shown by graphs and hatchings.

When a parallel light (illumination light) is irradiated onto the surface of the wafer 10, the reflected light becomes a specular reflected light if the surface of the wafer 10 is flat, as shown in FIG. 5. If a foreign substance 19 is attached on the surface of the wafer 10, the reflected light is scattered, and variable densities appear due to the influence of the foreign substance 19 in the image of the wafer 10 photographed with reflected light, which makes it possible to detect the foreign substance 19. This is the same for a case of a scratch 18 generated on the surface of the wafer 10.

However, if the resist layer 16 on the top layer is illuminated and the reflected light thereof is photographed and inspected, the illumination light interferes at the portion of the processed film 15 located in a layer lower than the resist layer 16, which is the top layer, and if the shape of the processed film 15 is not uniform, the degree of interference does not become uniform either, so interference light of which brightness is not uniform is included in the reflected light. As FIGS. 4(a) and (b) show, the interference light of which brightness is not uniform generates variable densities in the image of the wafer 10 photographed by the reflected light, which makes it impossible to distinguish a variable density due to the influence of a scratch 18 and foreign substance 19 and a variable density due to interference light of which brightness is not uniform, and therefore the accuracy of the wafer inspection drops.

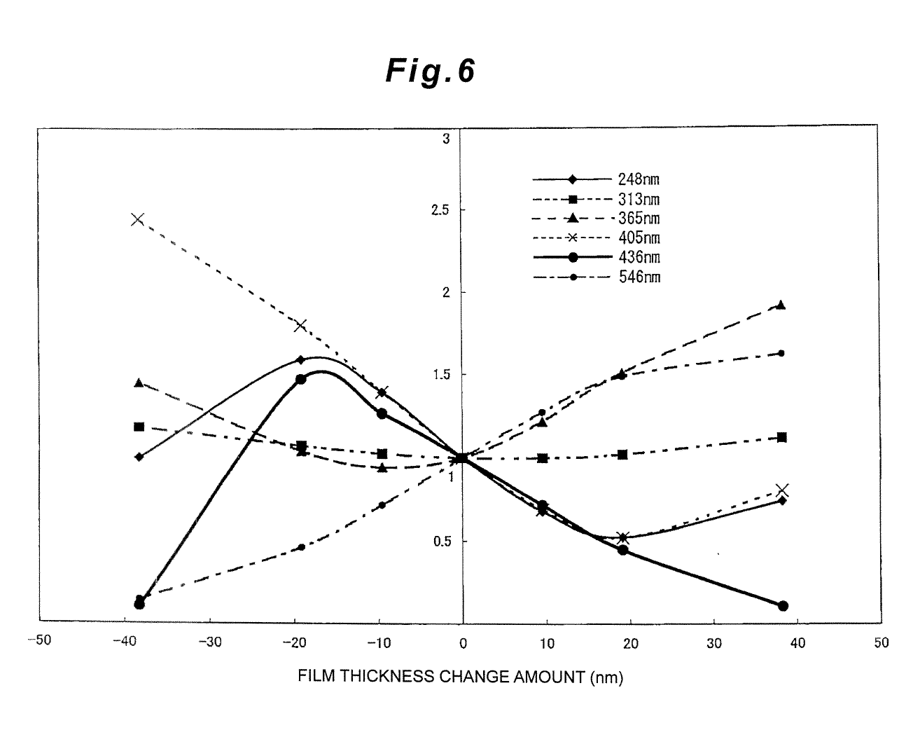

On the other hand, as shown in FIG. 4(C), if the same wafer 10 is illuminated using an illumination light having two wavelengths of an e-line and g-line, on the other hand, an image 55, which does not have much unevenness of density generated by interference light having uneven brightness, is photographed. This is because the characteristics of the brightness of the interference light, with respect to the film thickness of the processed film when an e-line is used and when a g-line is used, are substantially symmetric, therefore if the wafer 10 is illuminated using an illumination light having two wavelengths of an e-line and g-line, the characteristics of brightness of the interference light cancel each other. FIG. 6 shows an example of the characteristics of the brightness of the interference light with respect to the film thickness of the processed film. If the photographed image generated like this is used as an inspection image 55, the wafer 10 can be inspected with high accuracy.

Therefore according to the inspection device 1a and the inspection method of the first embodiment, in which the inspection image of the wafer 10 is generated with performing a predetermined weighting for each of the plurality of kinds of wavelengths and the presence of a defect on the wafer 10 is judged based on the generated inspection image, the unevenness of density due to interference light of which brightness is not uniform, can be decreased, and the influence of the underlayer when the wafer 10 is inspected can be decreased, so accuracy of the wafer inspection can be improved.

As mentioned above, it is also possible to create an inspection image using two kinds of wavelengths, so as to decrease the unevenness density generated by an interference light of which brightness is not uniform, but if three or more kinds of wavelengths are used, the uneven density generated by an interference light of which brightness is not uniform can be decreased with more certainty, and the influence of the underlayer when the waver 10 is inspected can be decreased with more certainty as well, and the accuracy of the wafer inspection can be further improved.

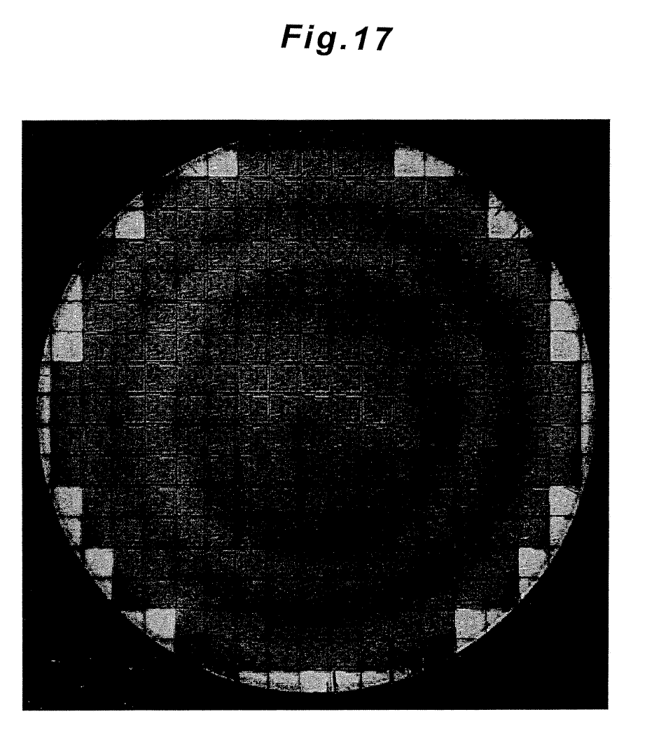

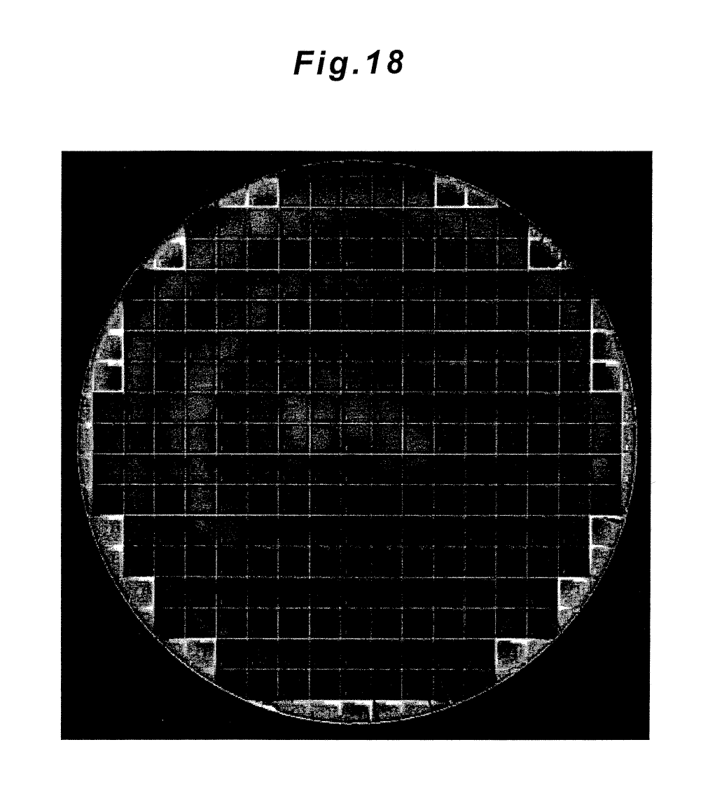

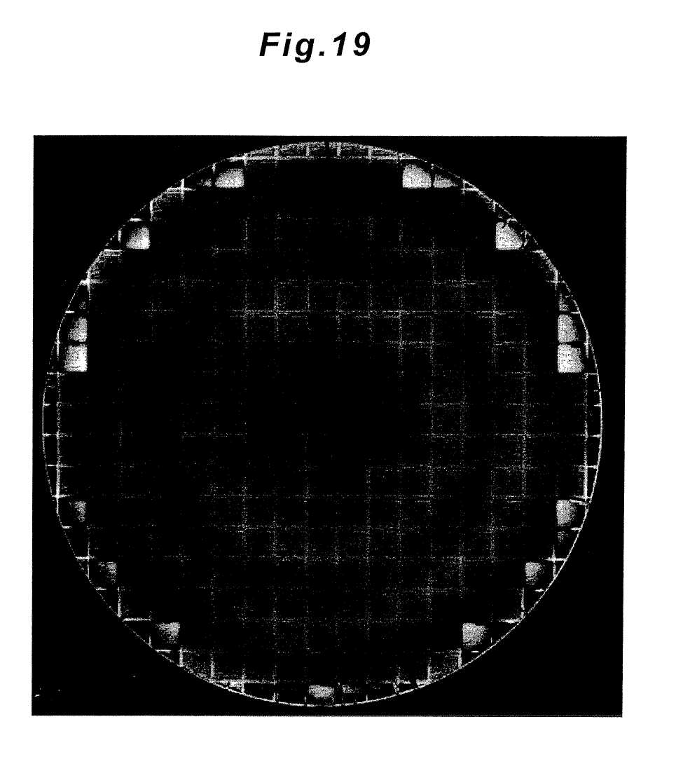

FIG. 17 to FIG. 19 show images actually photographed according to the present embodiment. FIG. 17 is a photographed image by illuminating the wafer with rays of an e-line according to the present embodiment. As FIG. 17 shows, concentric unevenness is generated. FIG. 18 is an image photographed by illuminating the wafer with rays of a g-line according to the present embodiment. In this case as well, concentric unevenness is generated. FIG. 19 is an image photographed by illuminating the wafer with rays of an h-line according to the present embodiment. Although unevenness is generated in FIG. 19 as well, the center area is dark, and the relationship in contrast is reversed with the unevenness of the image obtained by illuminating the wafer with an e-line shown in FIG. 17.

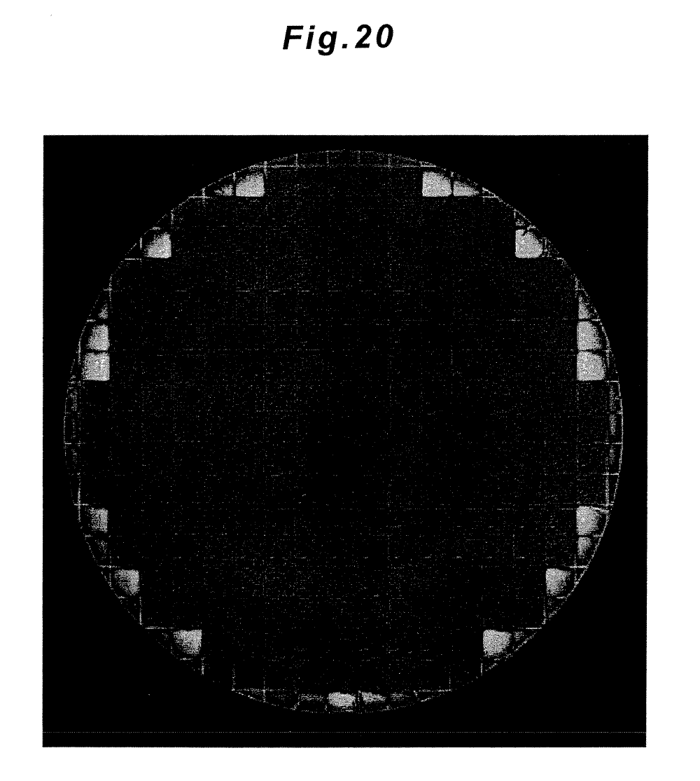

FIG. 20 is an image when the image in FIG. 17 and the image in FIG. 19 are weighted so that unevenness is cancelled, and are synthesized. As FIG. 20 shows, an image with little unevenness in general is obtained, and inspection with high accuracy can be implemented with decreasing the influence of unevenness.

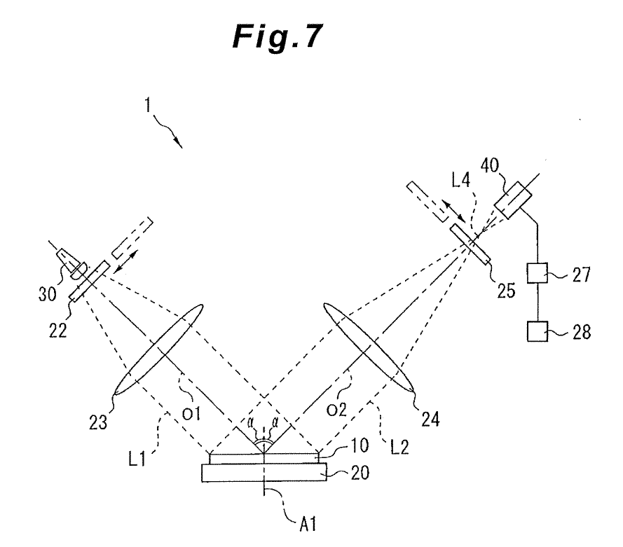

A second embodiment of the inspection device will now be described. As shown in FIG. 7, the inspection device 1b of the second embodiment has a configuration similar to the inspection device 1a of the first embodiment, but a difference from the inspection device 1a of the first embodiment is that the illumination side polarizing filter 22 is inserted on the optical path between the illumination unit 30 and the illumination optical system 23, and the receive side polarizing filter 25 is inserted on the optical path between the observation optical system 24 and the photographing unit 40.

On the surface of the wafer 10, a plurality of chip areas 11 are arrayed in the X and Y directions, as shown in FIG. 8, and a predetermined repeat pattern 12 is formed in each chip area. The repeat pattern 12 is a resist pattern (e.g. interconnect pattern) in which a plurality of line portions 2A are arrayed at a predetermined pitch P along the lateral direction (X direction), as shown in FIG. 9. A space portion 2B is a portion between adjacent line portions 2A. The array direction (X direction) of the line portion 2A is called the “repeating direction of the repeat pattern 12”.

Here it is assumed that the design value of the line width D_{A} of the line portion 2A in the repeat pattern 12 is ½ of the pitch P. If the repeat pattern 12 is precisely formed according to the design values, the line width D_{A} of the line portion 2A is the same as the line width D_{B} of the space portion 2B, and the volume ratio of the line portion 2A and the space portion 2B are approximately 1:1. If the exposure focus when the repeat pattern 12 is formed deviates from an optimum value, on the other hand, the pitch P is the same, but the line width D_{A} of the line portion 2A becomes different from the design value, and also becomes different from the line width D_{B} of the space portion 2B, and as a result, the volume ratio of the line portion 2A and the space portion 2B deviates from the approximately 1:1.

In the inspection device 1b of the second embodiment, defects of the repeat pattern 12 are inspected using this change of volume ratio of the line portion 2A and the space portion 2B in the repeat pattern 12. To simplify description, an ideal volume ratio (design value) is assumed to be 1:1. A change of volume ratio is caused by the deviation of the exposure focus from an optimum value, and could appear in each shot area of the wafer 10. The volume ratio can also be called an “area ratio of sectional form”.

In the present embodiment, it is assumed that the pitch P of the repeat pattern 12 is sufficiently small compared with the wavelength of the illumination light for the repeat pattern 12 (described later). Therefore diffracted light is not generated from the repeat pattern 12, and a defect inspection of the repeat pattern 12 cannot be performed using the diffracted light. The principle of defect inspection according to the present embodiment will be sequentially described along with the configuration of the device (FIG. 7).

The stage 20 rotatably holds the wafer 10, with the normal line A1 of the stage 20 as the rotation axis, and can rotate the repeating direction (X direction in FIG. 8 and FIG. 9) of the repeat pattern 12 on the wafer 10 within the surface of the wafer 10. The stage 20, according to the second embodiment, stops at a predetermined rotation position, and holds the repeating direction (X direction in FIG. 8 and FIG. 9) of the repeat pattern 12 on the wafer 10 to be tilted by 45° from the later mentioned entrance plane of the illumination light (traveling direction of the illumination light).

The illumination side polarizing filter 22 transmits the illumination light from the illumination unit 30 and transforms it into a first linearly polarized light L1 having three kinds of wavelengths (first to third wavelengths), which is irradiated onto the surface of the wafer 10 via the illumination optical system 23. This linearly polarized light L1 is the illumination light of the present embodiment.

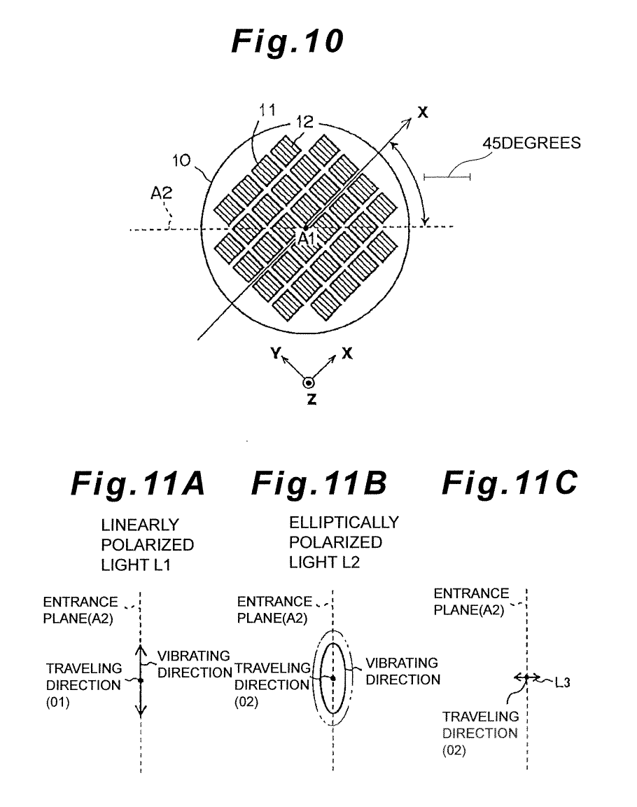

The traveling direction of the first linearly polarized light L1 (direction of the principal ray of the linearly polarized light L1 which arrives at an arbitrary point on the surface of the wafer 10) is substantially in parallel with the optical axis O1 from the illumination unit 30. The optical axis O1 passes through the center of the stage 20, and is a predetermined tilted angle α from the normal line A1 of the stage 20. A plane, which includes the traveling direction of the first linearly polarized light L1 and is in parallel with the normal line A1 of the stage 20, is the entrance plane of the linearly polarized light L1. The entrance plane A2 in FIG. 10 is an entrance plane at the center of the wafer 10.

In the present embodiment, the first linearly polarized light L1 is p polarization. In other words, as FIG. 11(a) shows, a plane that includes the traveling direction of the linearly polarized light L1 and a vibrating direction of the electric (or magnetic) vector (vibrating plane of the linearly polarized light L1) is included in the entrance plane A2 of the linearly polarized light L1. The vibrating plane of the linearly polarized light L1 is specified by the transmission axis of the illumination side polarizing filter 22. The entrance angle of the linearly polarized light L1 at each point of the wafer 10 is the same because of the parallel light, and corresponds to the angle α formed by the optical axis O1 and the normal line A1.

The linearly polarized light L1 that enters the wafer 10 is p polarization, so if the repeating direction (X direction) of the repeat pattern 12 is set to be a 45° angle from the entrance plane A2 of the linearly polarized light L1 (traveling direction of the linearly polarized light L1 on the surface of the wafer 10), as shown in FIG. 10, the angle formed by the direction of the vibrating plane of the linearly polarized light L1 on the surface of the wafer 10 and the repeating direction (X direction) of the repeat pattern 12 is also set to 45°.

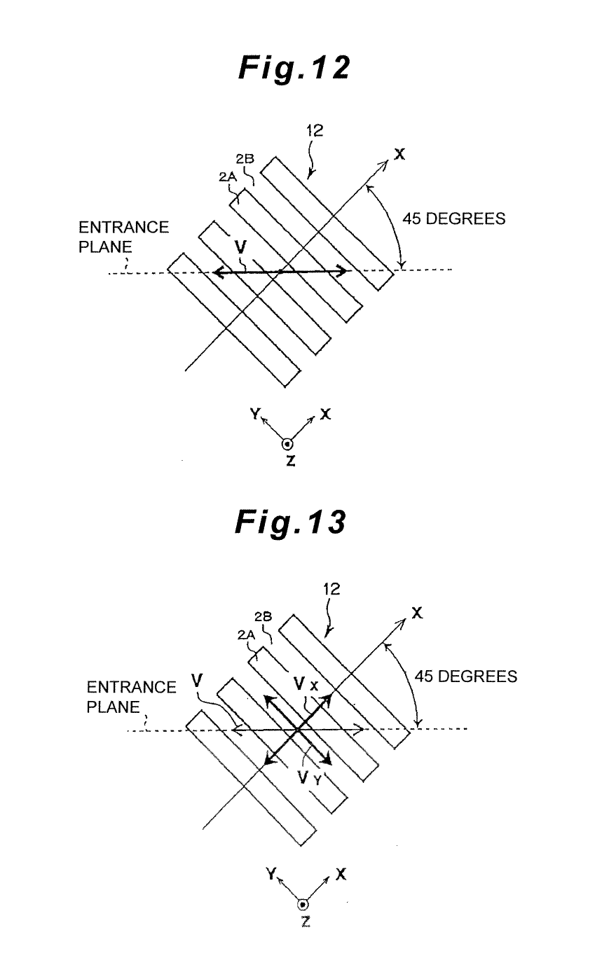

In other words, the first linearly polarized light L1 enters the repeat pattern 12 diagonally crossing the repeat pattern 12, such that the direction of the vibrating plane of the linearly polarized light L1 on the surface of the wafer 10 (V direction in FIG. 12) is tilted by 45° from the repeating direction (X direction) of the repeat pattern 12.

The state of the angle between the first linearly polarized light L1 and the repeat pattern 12 is the same on the entire surface of the wafer 10. The state of the angle between the first linearly polarized light L1 and the repeat pattern 12 is the same even if the above mentioned 45° is changed to 135°, 225° or 315°. This is because the angle formed by the direction of the vibrating plane (V direction) and the repeating direction (X direction) in FIG. 12 is set to 45° so that the sensitivity of the defect inspection for the repeat pattern 12 is maximized.

If the repeat pattern 12 is illuminated using the first linearly polarized light L1, the elliptically polarized light L2 is generated from the repeat pattern 12 in the specular reflection direction (see FIG. 7 and FIG. 11(b)). In this case, the traveling direction of the elliptically polarized light L2 matches with the specular reflection direction. The specular reflection direction is a direction included in the entrance plane A2 of the linearly polarized light L1, and is tilted by angle α (angle the same as entrance angle α of the linearly polarized light L1) from the normal line A1 of the stage 20. As mentioned above, the diffracted light is not generated from the repeat pattern 12 because the pitch P of the repeat pattern 12 is relatively longer than the illumination wavelength.

Now it will be described in brief why the first linearly polarized light L1 is transformed to be elliptic by the reflection of the repeat pattern 12, and the elliptically polarized light L2 is generated from the repeat pattern 12. When the first linearly polarized light L1 enters the repeat pattern 12, the light in the direction of the vibrating plane (V direction in FIG. 12) is split into two polarization components, V_{X} and V_{Y}, shown in FIG. 13. One polarization component V_{X} is a component in parallel with the repeating direction (X direction). The other polarization component V_{Y} is a component perpendicular to the repeating direction (X direction). The two polarization components V_{X} and V_{Y} receive a different amplitude change and phase change independently. The amplitude change and the phase change are different because the complex reflectance (that is, the amplitude reflectance of a complex number) is different due to the anisotropy of the repeat pattern 12, and this is called “form birefringence”. As a result, the two reflected lights having polarization components V_{X} and V_{Y} have different amplitude and phase from each other, and the reflected light generated by synthesizing these lights becomes elliptically polarized light L2 (see FIG. 11(b)).

The degree of elliptical polarization due to anisotropy of the repeat pattern 12 can be regarded as the polarization component L3 (see FIG. 11(c)), which is perpendicular to the vibrating plane of the linearly polarized light L1 shown in FIG. 11(a), out of the elliptically polarized light L2 shown in FIG. 11(b). The magnitude of this polarization component L3 depends on the material and shape of the repeat pattern 12, and the angle formed by the direction of the vibrating plane (V direction) in FIG. 12 and the repeating direction (X direction). Therefore if the angle formed by the V direction and the X direction is maintained to be a predetermined value (45° in the case of the present embodiment), and the degree of elliptical polarization (magnitude of the polarization component L3) changes if the shape of the repeat pattern 12 changes, even if the material of the repeat pattern 12 is the same.

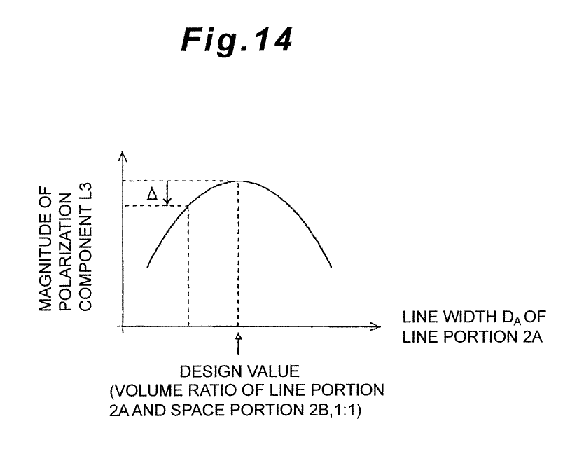

Now the relationship between the shape of the repeat pattern 12 and the magnitude of the polarization component L3 will be described. As FIG. 9 shows, the repeat pattern 12 has a bump shape where the line portion 2A and the space portion 2B are alternately arrayed along the X direction, and if the repeat pattern 12 is precisely formed according to the design values by an optimum focus, then the line width D_{A} of the line portion 2A and the line width D_{B} of the space portion 2B become the same, and the volume ratio of the line portion 2A and the space portion 2B becomes approximately 1:1. In the case of this ideal shape, the magnitude of the polarization component L3 becomes the maximum. If the exposure focus deviates from the optimum value, on the other hand, the volume ratio of the line portion 2A and the space portion 2B deviate from approximately 1:1. In this case, the magnitude of the polarization component L3 becomes smaller than the ideal case. FIG. 14 shows the change of the magnitude of the polarization component L3. The abscissa of FIG. 14 is a line width D_{A} of the line portion 2A.

If the repeat pattern 12 is illuminated in using the first linearly polarized light L1, in a state where the direction of the vibrating plane (V direction) in FIG. 12 is tilted by 45° from the repeat direction (X direction) of the repeat pattern 12, the elliptical degree (magnitude of the polarization component L3 in FIG. 11(c)) of the elliptically polarized light L2 generated by the light being reflected in the specular reflection direction corresponds to the shape (volume ratio of the line portion 2A and the space portion 2B) of the repeat pattern 12. The traveling direction of the elliptically polarized light L2 is included in the entrance plane A2 of the linearly polarized light L1, and is tilted by angle α from the normal line A1 of the stage 20.

The optical axis O2 of the observation optical system 24 passes through the center of the stage 20 and is set to be tilted by angle α from the normal line A1 of the stage 20. Therefore the elliptically polarized light L2, which is the reflected light from the repeat pattern 12, travels along the optical axis O2.

The receive side polarizing filter 25 transmits the specular reflected light from the surface of the wafer 10, and transforms it into the second linearly polarized light L4. The orientation of the transmission axis of the receive side polarizing filter 25 is set to be perpendicular to the transmission axis of the illumination side polarizing filter 22. In other words, the vibrating direction of the second linearly polarized light L4 on a plane perpendicular to the traveling direction of the second linearly polarized light L4 is set to be perpendicular to the vibrating direction of the first linearly polarized light L1 on a plane perpendicular to the traveling direction of the first linearly polarized light L1.

Therefore when the elliptically polarized light L2 transmits through the receive side polarizing filter 25, only a linearly polarized light L4 corresponding to the polarization component L3 of the elliptically polarized light L2 in FIG. 11(c) is extracted and is guided to the photographing unit 40. As a result, the reflected images of the wafer 10 by the second linearly polarized light L4, which is split for each of the three kinds of wavelengths by the imaging optical system 45, are formed on the first to third image sensing elements 41a, 41b and 41c in the photographing unit 40 respectively. The contrast of the reflected image of the wafer 10 is substantially in proportion to the light intensity of the linearly polarized light L4, and changes according to the shape of the repeat pattern 12. The reflected image of the wafer 10 becomes brightest when the repeat pattern 12 has an ideal shape.

An inspection method for the surface of the wafer 10 using the inspection device 1b according to second embodiment will now be described with reference to the flow chart shown in FIG. 16. First in step S101, parameters are set for the inspection target, just like the case of the first embodiment. Then in step S102, the wafer 10 to be the inspection target is transported to the stage 20, just like the case of the first embodiment.

In step S103, the illumination unit 30 illuminates the wafer 10 with an illumination light having three kinds of wavelengths (first to third wavelengths). The illumination light emitted from the illumination unit 30 at this time is transformed to the first linearly polarized light L1 by the illumination side polarizing filter 22, is made into parallel light by the illumination optical system 23, and is irradiated on the surface of the wafer 10. The specular reflected light reflected on the surface of the wafer 10 is condensed by the observation optical system 24, and the elliptically polarized light L2 is transformed to the second linearly polarized light L4 by the receive side polarizing filter 25, and is guided to the photographing unit 40.

In step S104, the wafer 10 illuminated by the first linearly polarized light L1 is photographed and recorded by the photographing unit 40. At this time, the second linearly polarized light L4 is split for each of the three kinds of wavelengths (first to third wavelengths) by the imaging optical system 45, and guided to the first to third image sensing elements 41a, 41b and 41c, and the reflected images of the wafer 10 by the second linearly polarized light L4 formed on the elements are photo-electric-transformed by each image sensing element 41a, 41b and 41c respectively, and image signals are output to the image processing unit 27.

When the images are photographed for each of the three kinds of wavelengths by the first to third image sensing elements 41a, 41b and 41c, the image processing unit 27, in steps S105 to S110, generates the inspection image of the wafer 10 by performing a predetermined weighting on the images photographed by the first to third image sensing elements 41a, 41b and 41c, and synthesizing these weighted images just like the case of the first embodiment. When the inspection image of the wafer 10 is generated, the image processing unit 27 in step S111 compares the brightness information thereof with the brightness information of the photographed image of a non-defective wafer, whereby the defects in the repeat pattern 12 (change of the volume ratio of the line portion 2A and the space portion 2B) are detected, and the presence of defects in the repeat pattern 12 is judged.

If the resist layer on the top layer, in which a repeat pattern is formed, is illuminated using the first linearly polarized light L1, the illumination light interferes at the portion of the processed film located in a layer lower than the resist layer on the top layer, and interference light, of which brightness is not uniform, is included in the reflected light, which is the same as the case of the first embodiment. However, the receive side polarizing filter 25 is disposed, so the specular reflected light in a portion where the form birefringence is not generated (repeat pattern 12 is not formed) is not detected by the photographing unit 40. In the case of the elliptically polarized light L2, which is a reflected light from the repeat pattern 12, on the other hand, the brightness (amplitude) changes by the interference, as shown in the two-dot chain line in FIG. 11(b), so interference light of which brightness is not uniform is included eventually if the shape of the processed film is not uniform. Therefore if the inspection image is generated, just like the case of the first embodiment, inspection of the wafer 10 with high accuracy can be implemented.

As a result, according to the inspection device 1b and the inspection method of the second embodiment, effects similar to the first embodiment can be implemented. Since the defects of the repeat pattern 12 are detected using the linearly polarized light, the defects inspection can be performed with certainty even if the pitch P of the repeat pattern 12 is sufficiently smaller than the illumination wavelength.

In the inspection device 1b of the second embodiment, the defects of the repeat pattern 12 can be inspected not only for the case of the pitch P of the repeat pattern 12 being sufficiently smaller than the illumination wavelength, but also for the case of the pitch P of the repeat pattern 12 being similar to the illumination wavelength, or a case of the pitch P being greater than the illumination wavelength. In other words, defects can be inspected with certainty, regardless the pitch P of the repeat pattern 12. This is because elliptical polarization of the linearly polarized light L1 due to the repeat pattern 12 is generated depending on the volume ratio of the line portion 2A and the space portion 2B of the repeat pattern 12, and does not depend on the pitch P of the repeat pattern 12.

In each of the above mentioned embodiments, the inspection image of the wafer 10 is generated by performing a predetermined weighting on images photographed by the first to third image sensing elements 41a, 41b and 41c for each of the three kinds of wavelengths, and synthesizing the weighted images, but the present invention is not limited to this. For example, as FIG. 15 shows, ND filters 34a, 34b and 34c may be disposed between the three condensing lenses 32a, 32b and 32c and the three mirrors 36, 37 and 38 respectively, so that a predetermined weighting is performed by adjusting the brightness of the illumination light, having the first to third wavelengths respectively using each ND filter 34a, 34b and 34c. In this case, the photographing unit 40 requires only one image sensing element, and does not require the imaging optical system 45.

In each of the above mentioned embodiments, the image processing unit 27 displays a photographed image generated with performing a predetermined weighting as the observation image on the image display device 28, without judging the presence of defects on the wafer surface 10 (or repeat pattern 12), so that the defects on the surface of the wafer 10 (or repeat pattern 12) are visually detected. In the case of using the present invention as such an observation device, as well, effects similar to the above embodiments can be implemented.

In the above embodiments, illumination light having three kinds of wavelengths is used, but the present invention is not limited to this, and can use a plurality of kinds of wavelengths, such as two kinds or four kinds.

What is claimed is:

1. An observation device, comprising:
an illumination unit that illuminates an inspection target substrate with illumination light having a plurality of kinds of wavelengths;
a photographing unit that photographs the inspection target substrate illuminated with the illumination light; and
a photographed image generation unit that generates an observation image of the inspection target substrate photographed by the photographing unit, while performing weighting for each of the plurality of kinds of wavelengths.

2. The observation device according to claim 1, wherein
the photographing unit comprises a plurality of image sensing elements disposed corresponding to the plurality of kinds of wavelengths, and an imaging optical system that splits the light from the inspection target substrate into each of the plurality of kinds of wavelengths and guides the split lights to the plurality of image sensing elements respectively, and
the photographed image generation unit generates the observation image, by weighting the image photographed for each of the plurality of kinds of wavelengths by the plurality of image sensing elements, and synthesizing the observation image.

3. An inspection device, comprising:
an illumination unit that illuminates an inspection target substrate with illumination light having a plurality of kinds of wavelengths;
a photographing unit that photographs the inspection target substrate illuminated with the illumination light;
a photographed image generation unit that generates an inspection image of the inspection target substrate, for which weighting is performed for each of the plurality of kinds of wavelengths; and
a judgment unit that judges whether any defect is present on the inspection target substrate based on the inspection image generated by the photographed image generation unit.

4. The inspection device according to claim 3, wherein
the illumination light that illuminates the inspection target substrate by the illumination unit is parallel light, and
the photographing unit photographs an image of the inspection target substrate generated by a specular reflected light from the inspection target substrate.

5. The inspection device according to claim 3, wherein
a predetermined repeat pattern is formed on a surface of the inspection target substrate,
the inspection device further comprising:
a first polarizing element that sends a first polarized state light, out of the illumination light, to the inspection target substrate;
a holding unit that holds the inspection target substrate so that the first polarized state on the surface of the inspection target substrate becomes diagonal with respect to the repeating direction of the repeat pattern; and
a second polarizing element that sends a second polarized state light, which is perpendicular to the first polarized state light, out of the reflected light from the inspection target substrate, to the photographing unit, and
the photographing unit photographs an image of the inspection target substrate formed by the second polarized state light.

6. The inspection device according to any one of claims 3 to 5, wherein the illumination unit comprises:
a plurality of illuminators which are disposed corresponding to the plurality of kinds of wavelengths, and each of which emits an illumination light having any of the plurality of kinds of wavelengths, that is different from the wavelengths of the other illuminators; and
a condensing optical system that synthesizes the illumination lights emitted from the plurality of illuminators and guides the illumination lights to the inspection target substrate.

7. The inspection device according to any one of claims 3 to 5, wherein
the plurality of kinds of wavelengths are set by at least three kinds of wavelengths, and
for a weighting ratio, a predetermined standard substrate is illuminated by the illumination unit and photographed by the photographing unit, and a ratio is set at which an inspection image of the standard substrate generated by the photographed image generation unit is substantially the same as an actual image of the standard substrate.

8. The inspection device according to any one of claims 3 to 5, wherein
a photographing unit comprises a plurality of image sensing elements disposed corresponding to the plurality of kinds of wavelengths, and an imaging optical system that splits a light from the inspection target surface into a plurality of kinds of wavelengths and guides each light into the plurality of light sensing elements respectively, and
the photographed image generation unit generates the inspection image by performing weighting and synthesizing the images photographed for each of the plurality of kinds of wavelengths by the plurality of image sensing elements respectively.

9. An inspection method comprising:
illuminating an inspection target substrate with illumination light having a plurality of kinds of wavelengths;
photographing the inspection target substrate illuminated by the illumination light;
generating an inspection image of the photographed inspection target substrate by performing weighting for each of the plurality of kinds of wavelengths; and
judging whether any defect is present on the inspection target substrate based on the generated inspection image.

10. The inspection method according to claim 9, wherein the illumination light from the inspection target substrate is split into each of the plurality of kinds of wavelengths when the inspection target substrate is photographed, and the inspection image is generated by performing weighting and synthesizing the images photographed for each of the plurality of kinds of wavelengths respectively.

11. The inspection device according to any one of claims 3 to 5, wherein the illumination unit comprises:
a plurality of illuminators which are disposed corresponding to the plurality of kinds of wavelengths, and each of which emits an illumination light having any of the plurality of kinds of wavelengths, that is different from the wavelengths of the other illuminators; and
a condensing optical system that synthesizes the illumination lights emitted from the plurality of illuminators and guides the illumination lights to the inspection target substrate, wherein
the plurality of kinds of wavelengths are set by at least three kinds of wavelengths, and
for a weighting ratio, a predetermined standard substrate is illuminated by the illumination unit and photographed by the photographing unit, and a ratio is set at which an inspection image of the standard substrate generated by the photographed image generation unit is substantially the same as an actual image of the standard substrate.

12. The inspection device according to any one of claims 3 to 5, wherein the illumination unit comprises:
a plurality of illuminators which are disposed corresponding to the plurality of kinds of wavelengths, and each of which emits an illumination light having any of the plurality of kinds of wavelengths, that is different from the wavelengths of the other illuminators; and
a condensing optical system that synthesizes the illumination lights emitted from the plurality of illuminators and guides the illumination lights to the inspection target substrate, wherein
a photographing unit comprises a plurality of image sensing elements disposed corresponding to the plurality of kinds of wavelengths, and an imaging optical system that splits a light from the inspection target surface into a plurality of kinds of wavelengths and guides each light into the plurality of light sensing elements respectively, and
the photographed image generation unit generates the inspection image by performing weighting and synthesizing the images photographed for each of the plurality of kinds of wavelengths by the plurality of image sensing elements respectively.

13. The inspection device according to any one of claims 3 to 5, wherein the illumination unit comprises:
a plurality of illuminators which are disposed corresponding to the plurality of kinds of wavelengths, and each of which emits an illumination light having any of the plurality of kinds of wavelengths, that is different from the wavelengths of the other illuminators; and
a condensing optical system that synthesizes the illumination lights emitted from the plurality of illuminators and guides the illumination lights to the inspection target substrate, wherein
the plurality of kinds of wavelengths are set by at least three kinds of wavelengths,
for a weighting ratio, a predetermined standard substrate is illuminated by the illumination unit and photographed by the photographing unit, and a ratio is set at which an inspection image of the standard substrate generated by the photographed image generation unit is substantially the same as an actual image of the standard substrate,
a photographing unit comprises a plurality of image sensing elements disposed corresponding to the plurality of kinds of wavelengths, and an imaging optical system that splits a light from the inspection target surface into a plurality of kinds of wavelengths and guides each light into the plurality of light sensing elements respectively, and
the photographed image generation unit generates the inspection image by performing weighting and synthesizing the images photographed for each of the plurality of kinds of wavelengths by the plurality of image sensing elements respectively.
